(19) United States
(12) Patent Application Publication
(10) Pub. No.: US 2008/0210817 A1
(43) Pub. Date: Sep. 4, 2008

(54) Energy-absorbing Square Tube Composite Stanchion

(75) Inventors: Paul S. Gregg, Normandy Park, WA (US); Lee C. Firth, Renton, WA (US); William J. Koch, Bellevue, WA (US)

Correspondence Address: THE BOEING COMPANY;c/o FELIX L. FISCHER, ATTORNEY AT LAW, 1607 MISSION DRIVE, SUITE 204, SOLVANG, CA, 93463, US

(73) Assignee: THE BOEING COMPANY, Chicago, IL (US)

(21) Appl. No.: 11/553,391

(22) Filed: Oct. 26, 2006

(51) Int. Cl. F16F 7/12; B64C 1/00; B64C 1/18

(52) U.S. Cl. 244/119; 244/117 R; 188/376

(57) ABSTRACT

An energy absorbing structural strut employs a composite tube bonded to an end fitting with the bond being slightly lower in strength than the crushing strength of the tube in axial compression. The end fitting incorporates an anvil to rupture the tube and absorb energy upon shearing of the bond with the strut in compression.

### BACKGROUND OF THE INVENTION

1. Field of the Invention

This invention relates generally to the field of crash survivability in composite structures and more particularly to a stanchion and end support engagement providing energy absorption capability through inter-laminar shear failure and corner fiber breakage in the stanchion by the end support under crash loads.

2. Description of the Related Art

During a vehicle crash such as a crash landing of an aircraft, the survivability of occupants in the vehicle is dependant on how well the structure can absorb the kinetic energy of the vehicle including the passengers and the cargo. In an aircraft, the stanchions which support the structure for passenger and cargo cabins play a major role in how well the overall structure can absorb the energy of a crash.

Like an automobile designed with crush-zones, there is a great advantage in an aircraft crash to be able to absorb energy with structure, providing less shock to the passengers. Most existing commercial and military aircraft airframes are metallic, which enhances their energy-absorbing qualities during impact. This is due to the inherent plasticity of metals and their relatively high strain to failure. Newer aircraft often contain a significant amount of composite material with better strength-to-weight ratio than metal, but the designs are driven by static load requirements. Crashworthiness issues can be compounded on aircraft comprised primarily of composites since these materials typically have a low failure strain relative to traditional metal structure. The low failure strain generally leads to component fracture as opposed to ductile failure typical of metallic structure.

Crushable composite structure have previously been investigated for use in helicopter structures as disclosed in U.S. Pat. No. 5,069,318 entitled Self-Stabilized Stepped Crashworthy Stiffeners and U.S. Pat No. 6,620,484 entitled Variable Density Stitched Composite Structural Elements for Energy Absorption. These structures relate to keel beam webs used in helicopters and not a columnar structure such as a stanchion for support of internal aircraft structures.

It is therefore desirable to provide structural elements such as stanchions which incorporate an energy absorption mechanism for enhanced crashworthiness of vehicles including aircraft which rely on composite structures.

### SUMMARY OF THE INVENTION

The present invention provides an energy absorbing structural strut employing a composite tube bonded to an end fitting with the bond being slightly lower in strength than the crushing strength of the tube in axial compression. The end fitting incorporates an anvil to rupture the tube and absorb energy upon shearing of the bond with the strut in compression.

In exemplary embodiments, a square (or rectangular) composite tube used as a stanchion with special end fittings having an attachment element for support of an aircraft structure by the stanchion and an engagement portion opposite the attachment element to be received in the composite tube. A joggle intermediate the attachment element and engagement portion acts as the anvil for creating lateral stresses in the composite tube matrix and plies to create rupturing of the matrix and plies to absorb energy during overload compression of the stanchion during a crash.

### BRIEF DESCRIPTION OF THE DRAWINGS

These and other features and advantages of the present invention will be better understood by reference to the following detailed description when considered in connection with the accompanying drawings wherein:

FIG. 1 is an isometric view of the stanchion tube and end fitting of one embodiment of the present invention;

FIG. 2 is a detailed view of the end fitting for the exemplary embodiment;

FIG. 3 is a section view of the end fitting and stanchion tube;

FIG. 4 is an exemplary post rupture configuration of the stanchion tube; and,

FIG. 5 is a partial cutaway view of an aircraft fuselage showing an exemplary embodiment of the present invention in an application supporting a passenger compartment floor.

### DETAILED DESCRIPTION OF THE INVENTION

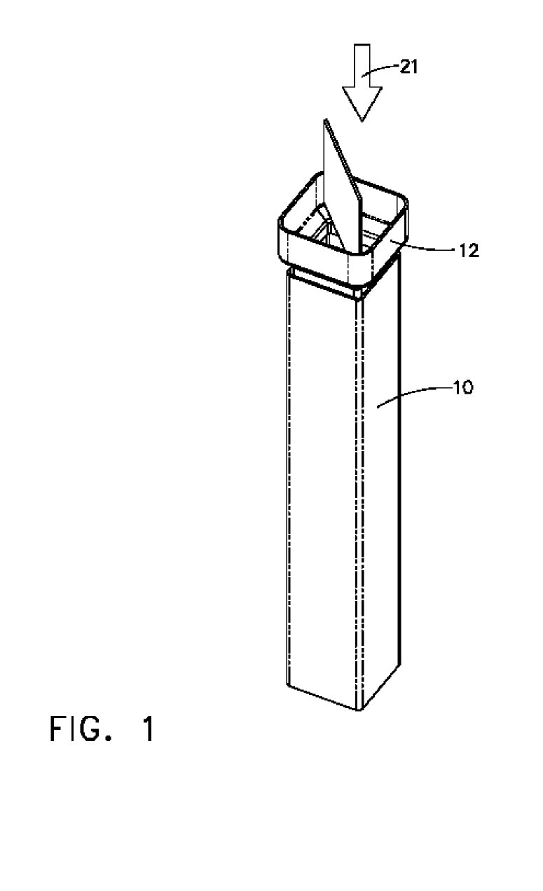

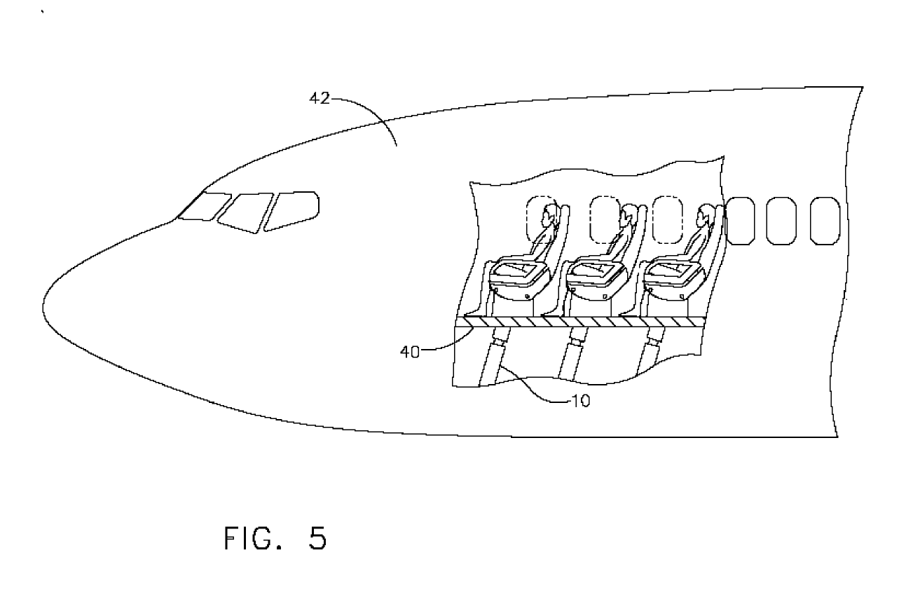

As shown in FIG. 1 the present invention provides a composite stanchion 10 with a special metallic end fitting 12. For the embodiment shown the stanchion is a square cross section tube having an open core 14 which receives a mating portion 16 of the end fitting. The end fitting serves as a primary means of stanchion attachment to the supported structure such as floor beams 40 and frames in an aircraft 42, as shown in FIG. 5, through a flange 18 opposite the mating portion received by the stanchion. In an exemplary embodiment, the end fitting and tube are joined by an adhesive attachment. In alternative embodiments, a mechanically fastened attachment is employed. “Fuse pins” made from fasteners are an exemplary fastening approach to provide a desired failure load and are easily incorporated into the design as an alternative to adhesive. The function of the end fitting in a crash scenario is to maintain attachment to the supporting structure and the alignment of the composite stanchion while pulverizing of the stanchion material occurs at the end fitting joggle 20 (best seen in FIG. 3) acting as an anvil.

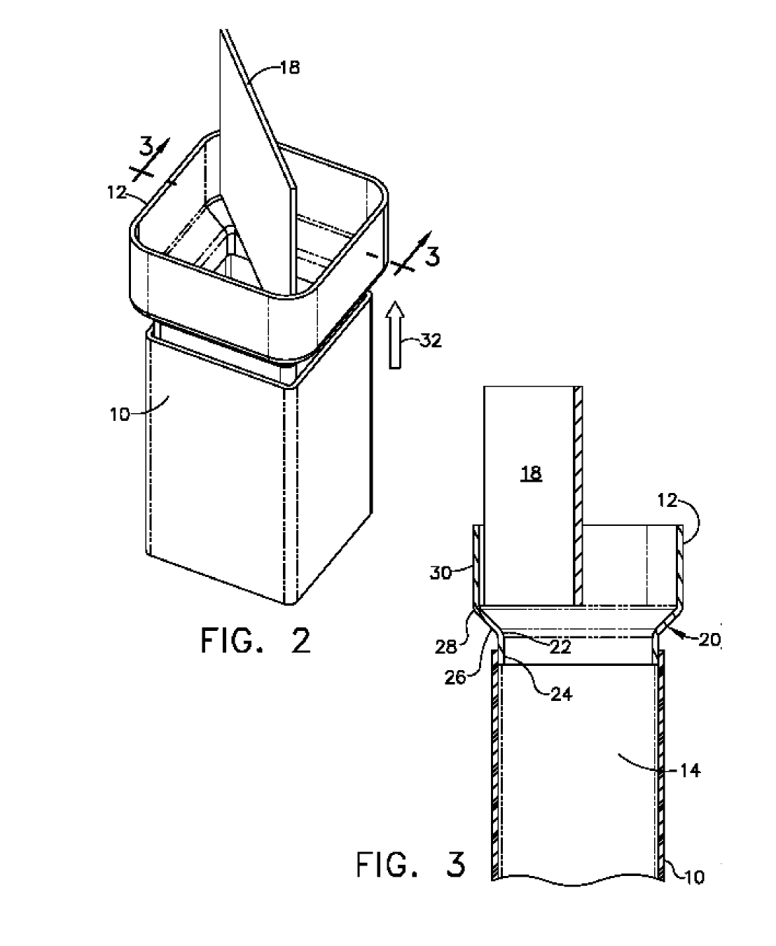

As shown in FIGS. 2 and 3, the end fitting provides an anvil created by the ramp for lateral displacement of the fiber matrix of the stanchion during axial loading (generally represented by arrow 21 (of FIG. 1) which exceeds the normal structural integrity of the system. For the embodiment shown, the ramp or joggle is created with a radius section 22 diverging from the rectangular tube engagement section 24 received in the core of the stanchion followed by a straight section 26 which is returned by radius 28 to a parallel section 30. The attachment structure of the end fitting is connected in the parallel section to provide the structural interface for the stanchion to the supported vehicle elements. In alternative embodiments the rectangular parallel section provides direct connection to the structure with appropriate fasteners or integral shaping in the cast or forged part.

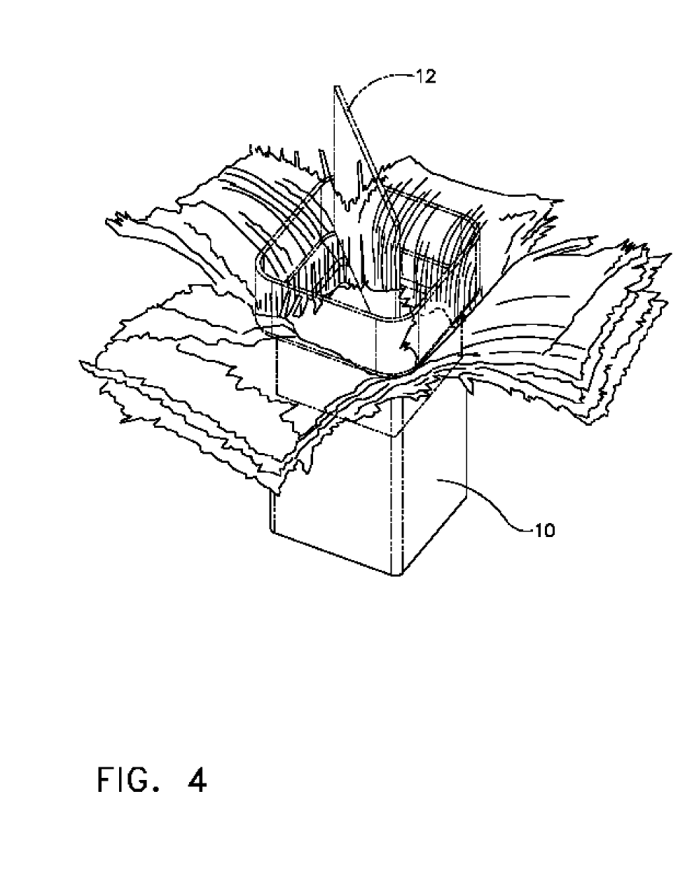

As the ultimate design load is exceeded by axial forces on the end fitting, the composite stanchion material begins to slide along the end fitting in the direction of arrow 32. The tapered end fitting begins to progressively fail stanchion material as the resin matrix and plies are expanded at the joggle. The results of a progressively fractured stanchion can be seen in FIG. 4. Under severe loading, as in an airplane crash, the end fitting is forced into the tube core and causes expansion of the tube over the joggle to the extent that progressive disintegration of the stanchion tube through inter-laminar shear failure and corner fiber breakage absorbs a significant amount of energy. This absorption of energy reduces the shock loads imparted to passengers and can greatly increase the chances of survival. The amount of energy absorbed by the composite is similar that that seen by a highly ductile metal.

In an exemplary embodiment as shown in the drawings, the stanchion comprises a 2 inch square graphite epoxy polymer matrix composite tube fabricated from 16-20 ply fabric for a wall thickness of approximately 125 inch. The end trim of the composite tube is tailored in certain embodiments for fatigue or optimum adhesive performance; for example, chamfering the tube edge to avoid a “square notch” which would tend to delaminate the bonded joint in fatigue over a long period of time. However, such tailoring does not affect the energy absorption or pulverization of the stanchion. In alternative embodiments, differing cross sectional shapes for the stanchion and associated end fitting engagement are employed.

The attachment end fitting is a forged and/or welded element fabricated from structural steel, titanium or high strength aluminum. For the exemplary embodiment, the joggle creates a total displacement of approximately 0.150 inch with the radius sections having a net radius of approximately 0.5 inch with the straight section having a length of approximately 0.5 inch. The stanchion tube disintegration pattern shown in FIG. 4 has been demonstrated in test elements employing a woven-fiber 5-ply fabric square tube in a dynamic drop test.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. An energy absorbing structural strut comprising:
a composite tube bonded to an end fitting with the bond being slightly lower in strength than the crushing strength of the tube in axial compression;
the end fitting incorporating an anvil to split the tube and absorb energy upon shearing of the bond with the strut in compression.

2. An energy absorbing structural strut as defined in claim 1 wherein the composite tube is rectangular in cross section.

3. An energy absorbing structural strut as defined in claim 2 wherein the end fitting incorporates a rectangular engagement portion received within the tube and the anvil comprises a lateral joggle in the end fitting.

4. An energy absorbing structural strut as defined in claim 3 wherein the end fitting further incorporates attachment means for a structural element supported by the strut, the joggle intermediate the attachment means and the engagement portion.

5. An energy absorbing structural strut as defined in claim 1 wherein the composite tube comprises a rectangular multiply graphite epoxy polymer matrix tube and the end fitting comprises a fabricated metallic element having a rectangular engagement portion received in an open core of the tube and a diverging joggle from the engagement portion to a structural attachment element.

6. An aircraft comprising an airframe including a structural aircraft strut having a composite tube bonded to an end fitting with the bond being slightly lower in strength than the crushing strength of the tube in axial compression;
the end fitting further comprising an anvil to split the tube and absorb energy during upon shearing of the bond with the strut in compression.

7. An aircraft as defined in claim 6 wherein the anvil comprises a lateral joggle in the end fitting

8. An aircraft as defined in claim 6 wherein the composite tube is rectangular in cross section.

9. An aircraft as defined in claim 7 wherein the end fitting incorporates a rectangular engagement portion received within the tube.

10. An aircraft as defined in claim 7 wherein the end fitting further incorporates attachment means for a structural element supported by the strut, the joggle intermediate the attachment means and the engagement portion.

11. A method of manufacturing structural elements in an aircraft comprising the steps of:
providing a composite tube having a predetermined lateral burst strength for the composite material;
providing an end fitting having an expansion anvil and terminating in an attachment element adjacent the anvil;
forming a bond between the composite tube and the attachment element of the end fitting such that the bond is lower in strength than the crushing strength of the tube.

12. A method as defined in claim 11 wherein the step of providing an end fitting includes the step of forming the expansion anvil by expanding a joggle in the end fitting proximate the attachment element.

13. A method as defined in claim 12 wherein the composite tube is rectangular in cross section.

14. A method for supporting a compartment floor in an aircraft comprising the steps of:
providing a plurality of end fittings attached to support a compartment floor, the end fittings including an engagement element and an anvil;
forming a bond between a composite tube having a predetermined lateral burst strength for the composite material and the engagement element of the end fitting such that the bond is lower in strength than the crushing strength of the tube.

15. A method for absorbing crash energy comprising the steps of:
providing a composite tube having a predetermined lateral burst strength for the composite material;
providing an end fitting having an expansion anvil and terminating in an attachment element adjacent the anvil;
forming a bond between the composite tube and the attachment element of the end fitting such that the bond is lower in strength than the crushing strength of the tube;
imposing an axial load on the end fitting in excess of the bond strength;
displacing the tube axially under the axial load; and,
rupturing matrix and ply fibers in the composite tube by lateral expansion over the anvil.
